(19) United States
(12) Patent Application Publication
(10) Pub. No.: US 2024/0230944 A1
(43) Pub. Date: Jul. 11, 2024

(54) ELECTROMAGNETIC MEASUREMENTS IN A CURVED WELLBORE

(71) Applicant: Schlumberger Technology Corporation, Sugar Land, TX (US)

(72) Inventor: Mark Frey, Sugar Land, TX (US)

(21) Appl. No.: 18/558,959

(22) PCT Filed: Jun. 27, 2022
(86) PCT No.: PCT/US2022/035125

§ 371 Date: Nov. 3, 2023

Related U.S. Application Data
(60) Provisional application No. 63/215,665, filed on Jun. 28, 2021.

(51) Int. Cl. G01V 3/38; G01V 3/24; G01V 3/28

(52) U.S. Cl. CPC G01V 3/38; G01V 3/24; G01V 3/28

(57) ABSTRACT

A method for making electromagnetic logging measurements in a curved section of a subterranean wellbore includes rotating an electromagnetic logging tool (including at least one transmitter and at least one receiver) in the curved section of the wellbore. A curvature value of the curved section of the wellbore is obtained and processed in combination (e.g., via an inversion algorithm) with the electromagnetic measurements to compute at least one property of a formation surrounding the wellbore.

### CROSS REFERENCE TO RELATED APPLICATIONS

This application claims the benefit of and priority to U.S. Provisional Patent Application No. 63/215,665, filed on Jun. 28, 2021. The patent application identified above is incorporated herein by reference in its entirety.

### BACKGROUND INFORMATION

The use of electromagnetic measurements in prior art downhole applications, such as logging while drilling (LWD) and wireline logging applications is well known. Such techniques may be utilized to determine a subterranean formation resistivity, which, along with formation porosity measurements, is often used to indicate the presence of hydrocarbons in the formation. Moreover, azimuthally sensitive directional resistivity measurements are commonly employed e.g., in pay-zone steering applications, to provide information upon which steering decisions may be made.

Certain modern drilling tools (e.g., rotary steerable drilling tools) are capable of drilling wellbore sections having a high dogleg severity (e.g., greater than 5 degrees or even 10 degrees per 100 feet of measured depth). LWD tools (e.g., electromagnetic LWD tools) may be configured to bend as they traverse the high dogleg section.

### SUMMARY

A method for making electromagnetic logging measurements in a curved section of a subterranean wellbore is disclosed. The method includes rotating an electromagnetic logging tool (including at least one transmitter and at least one receiver) in the curved section of the wellbore. The electromagnetic logging tool makes electromagnetic measurements while rotating. A curvature value of the curved section of the wellbore is obtained and processed in combination (e.g., via an inversion algorithm) with the electromagnetic measurements to compute at least one property of a formation surrounding the wellbore.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig on which disclosed embodiments may be utilized.

FIG. 2A depicts one example of a deep reading electromagnetic logging tool shown on FIG. 1 including spaced apart transmitter and receiver subs.

FIG. 2B depicts another example of a suitable electromagnetic logging tool.

FIG. 3 depicts a flow chart of one disclosed method embodiment.

FIGS. 4A and 4B schematically depict one example of BHA bending.

FIGS. 5A and 5B depict flow charts providing further detail for one embodiment of the method depicted on FIG. 3.

### DETAILED DESCRIPTION

Disclosed embodiments relate generally to electromagnetic logging measurements and more particularly to methods for making and processing electromagnetic measurements that account for bending of the bottom hole assembly. Applicants identified that bending can influence the accuracy of the corresponding LWD measurements, especially in deep reading electromagnetic measurements that employ a long spacing between the transmitter and receiver.

A method for making electromagnetic logging measurements in a curved section of a subterranean wellbore is disclosed. The method includes rotating an electromagnetic logging tool (including at least one transmitter and at least one receiver) in the curved section of the wellbore. The electromagnetic logging tool makes electromagnetic measurements while rotating. A curvature value of the curved section of the wellbore is obtained and processed in combination (e.g., via an inversion algorithm) with the electromagnetic measurements to compute at least one property of a formation surrounding the wellbore.

In some embodiments, improved measurement accuracy (and improved formation evaluation accuracy) may be obtained when making electromagnetic measurements in a curved section of wellbore. In some embodiments, a forward model used in an inversion algorithm makes use of a wellbore curvature estimate or measurement to compute modeled measurements in the curved section of the wellbore, thereby accounting for the curvature of the wellbore rather than attempting to remove effects of curvature from the measurement. Such processing may provide for improved accuracy and eliminate artifacts that would be present if well curvature were not taken into account. Artifacts that may be eliminated may include, for example, errors in the mapping of the location of bed boundaries, errors in the determination of the resistivity of the bedding, or false detection of bedding.

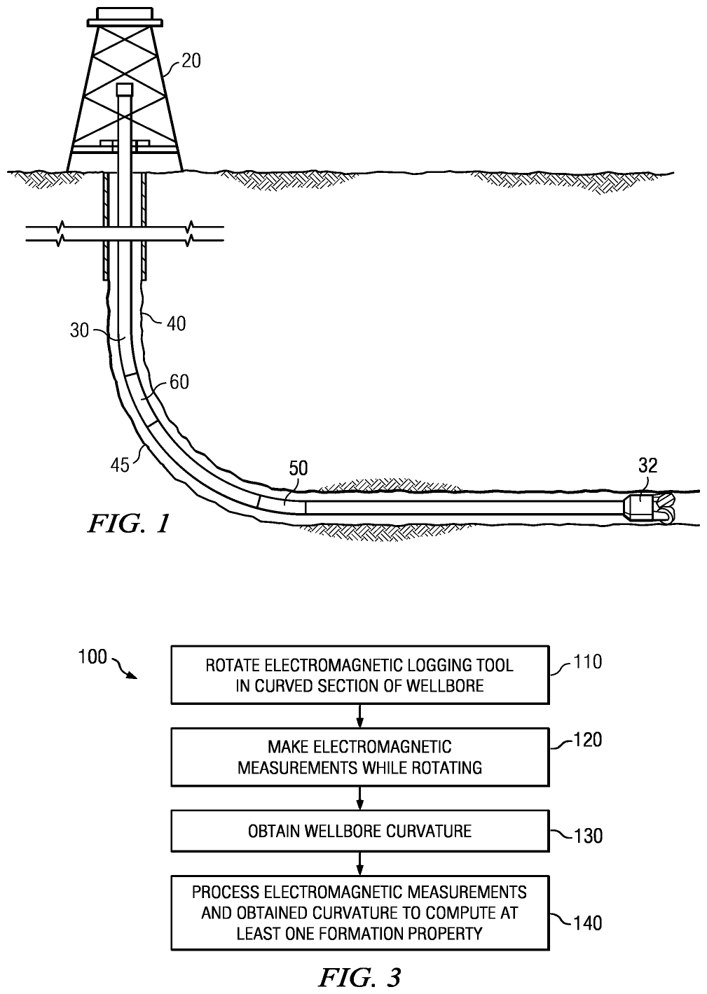

FIG. 1 depicts an example drilling rig 20 suitable for employing various method embodiments disclosed herein. The rig is positioned over an oil or gas formation (not shown). The platform may include a derrick and a hoisting apparatus for raising and lowering a drill string 30, which, as shown, extends into wellbore 40 and includes a drill bit 32 deployed at the lower end of a bottom hole assembly (BHA) 35. In the depicted embodiment, the drill string further includes a deep reading electromagnetic measurement tool including distinct transmitter 50 and receiver 60 subs configured to make directional (e.g., tri-axial) electromagnetic logging measurements in the wellbore 40 (e.g., curved section 45 of wellbore 40).

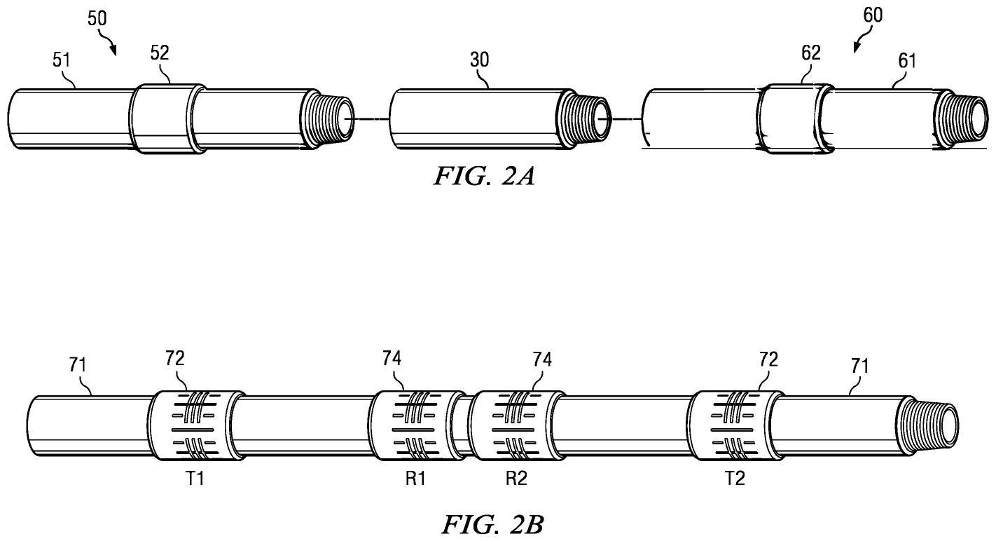

The deployment illustrated on FIG. 1 is merely an example. Drill string 30 may include substantially any suitable downhole tool components, for example, including a steering tool such as a rotary steerable tool, a downhole telemetry system, and one or more additional MWD and/or LWD tools including various sensors for sensing downhole characteristics of the borehole and the surrounding formation. The disclosed embodiments are by no means limited to any particular drill string configuration. Moreover, the electromagnetic transmitter(s) and receiver(s) may alternatively be deployed on a single sub or tool body (see FIG. 2B) as the disclosed embodiments are not limited to deep reading electromagnetic measurements.

The disclosed embodiments are not limited to use with a land rig 20 as illustrated on FIG. 1 and may be equally well suited for use with either onshore or offshore subterranean operations. Moreover, disclosed embodiments are not limited to logging while drilling embodiments as illustrated on FIG. 1. The disclosed embodiments are equally well suited for use with any electromagnetic logging tool, including wireline logging tools and logging while drilling tools.

FIGS. 2A and 2B depict example embodiments of suitable electromagnetic measurement tools. On FIG. 2A, the electromagnetic measurement tool includes distinct transmitter and receiver subs 50 and 60. As depicted, the transmitter sub (or tool) 50 includes at least one electromagnetic transmitter 52 deployed on a transmitter collar 51. The receiver sub (or tool) 60 includes at least one electromagnetic receiver 62 deployed on a receiver collar 61. When deployed in a drill string (e.g., drill string 30 on FIG. 1), the transmitter and receiver subs 50 and 60 may be axially spaced apart substantially any suitable distance to achieve a desired measurement depth (e.g., in a range from about 20 to about 100 or 200 feet or more depending on the measurement objectives). While not shown, one or more other BHA tools may be deployed between subs 50 and 60.

As described in more detail below the transmitter 52 and receiver 62 may each include tri-axial antennas (e.g., an axial antenna and first and second transverse antennas that are orthogonal to one another). As is known to those of ordinary skill in the art, an axial antenna is one whose moment is substantially parallel with the longitudinal axis of the tool. Axial antennas are commonly wound about the circumference of the logging tool such that the plane of the antenna is substantially orthogonal to the tool axis. A transverse antenna is one whose moment is substantially perpendicular to the longitudinal axis of the tool. A transverse antenna may include, for example, a saddle coil (e.g., as disclosed in U.S. Patent Publications 2011/0074427 and 2011/0238312). Transmitter 52 and receiver 62 may alternatively and/or additionally include one or more tilted antennas. Tilted antennas are commonly wound about the circumference of the logging tool such that the plane of the antenna is angled with respect to the tool axis (e.g., at an angle of about 45 degrees). Such antenna configurations are well known in the industry.

In the FIG. 2B embodiment, the tool includes at least one electromagnetic transmitter transmitter 72 and at least one electromagnetic receiver 74 deployed on a common tool collar (or body) 71. One common configuration includes first and second spaced transmitters T1 and T2 deployed about a pair of spaced receivers R1 and R2 on the collar 71 (as depicted). The disclosed embodiments are not limited to tool embodiments including any particular number of transmitters and/or receivers. Moreover, as described above, individual ones of the transmitter(s) 72 and receiver(s) 74 may include substantially any suitable number and combination of antennas including, for example, axial, transverse, tilted antennas, and collocated combinations thereof. In one suitable embodiment, at least one of the transmitter(s) and receiver(s) includes a triaxial antenna arrangement including an axial antenna and first and second transverse antennas that are orthogonal to one. The disclosed embodiments are expressly not limited in these regards.

By convention, axial antennas are referred to herein as z antennas or z-axis antennas and that the transverse antennas are referred to herein as the x antennas or x-axis antennas. Transverse antennas may also be referred to as y antennas or y-axis antennas. A tilted antenna may also be referred to as an xz (or yz) antenna. The disclosed embodiments are of course not limited by such conventional nomenclature. Moreover, transmitter receiver couplings are commonly referred to as xx and zz direct couplings (an x transmitter coupled with an x receiver or a z transmitter coupled with a z receiver) or xz and zx cross couplings (an x transmitter coupled with a z receiver or a z transmitter coupled with an x receiver). As described in more detail below, using such nomenclature a tri-axial antenna arrangement may be referred to as including collocated x, y, and z antennas. Those of ordinary skill will readily appreciate and understand such nomenclature.

With continued reference to FIGS. 2A and 2B, and according to the described embodiments below, the terms “transmitter” and “receiver” are used to describe different functions of an antenna, as if they were different types of antennas. This is only for illustration purposes. A transmitting antenna and a receiving antenna have the same physical characteristics, and one of ordinary skill in the art would appreciate that the principle of reciprocity applies and that a radiating element may be used as a transmitter at one time and as a receiver at another. Thus, any specific description of transmitters and receivers in a particular tool embodiment should be construed to include the complementary configuration, in which the “transmitters” and the “receivers” are switched. Furthermore, in this description, a “transmitter” or a “receiver” is used in a general sense and may include a single radiating element, two radiating elements, or three radiating elements.

As is known to those of ordinary skill, subterranean drilling operations commonly drill deviated wellbores having non vertical and horizontal sections. Such wellbores may include complex profiles, including, for example, vertical, tangential, and horizontal sections as well as one or more curves (including builds, turns, and/or other doglegs) between such sections. The bottom hole assembly (BHA) and drill string bends as it follows the drill bit through the curved sections of the wellbore. As noted above in the Background Section certain modern drilling tools are capable of drilling wellbore sections having a high dogleg severity (e.g., greater than 5 degrees or even 10 degrees per 100 feet of measured depth). LWD tools (e.g., electromagnetic LWD tools) may be configured to bend as they traverse the high dogleg section. Such bending can influence the accuracy of the corresponding LWD measurements, especially in deep reading electromagnetic measurements that employ a long spacing between the transmitter and receiver.

FIG. 3 depicts a flow chart of one example method embodiment 100. An electromagnetic logging tool (e.g., an LWD tool) is rotated in a curved section of a wellbore at 110. Electromagnetic measurements are made at 120 while the logging tool is rotated in 110, for example, by firing one or more of the transmitters and receiving corresponding voltages at one or more of the receivers. The curvature of the wellbore or the BHA may be obtained or measured at 130. The electromagnetic measurements made in 120 and the curvature obtained in 130 are processed in combination at 140 (e.g., via inversion as described in more detail below) to compute one or more properties of the subterranean formation through which the wellbore penetrates.

As is known to those of ordinary skill in the art, electromagnetic measurements are made in a wellbore by firing a transmitter (or transmitters) and measuring a corresponding voltage response in one or more spaced receivers (i.e., by firing a transmitting antenna and measuring the voltage response in a receiving antenna). As is also known to those of ordinary skill, a time varying electric current (an alternating current) in a transmitting antenna produces a corresponding time varying magnetic field in the local environment (e.g., the tool collar and the formation). The magnetic field in turn induces electrical currents (eddy currents) in the conductive formation. These eddy currents further produce secondary magnetic fields which may produce a voltage response in a receiving antenna. The measured voltage in the receiving antennae can be processed, as is known to those of ordinary skill in the art, to obtain one or more properties of the formation.

Since the logging tool is rotating during data acquisition (e.g., at 60 rpm, 120 rpm, 180 rpm or more), the toolface angle θ (the rotational orientation) of the logging tool varies with each firing of the transmitter(s). The toolface angle θ is commonly measured at each transmitter firing (or at some predetermined interval while rotating). The measured voltages at the receiver(s) may then be paired with corresponding toolface measurements. Those of ordinary skill in the art will readily appreciate that the above toolface (rotational orientation measurements) may be made, for example, via triaxial magnetometer measurements (or other known methods).

The measured voltages may be expressed mathematically in terms of their harmonic voltage coefficients, for example, as follows:

$${V}_{ij} = {V}_{D C \_ ij} + {V}_{FHC \_ ij} cos ( θ ) + {V}_{FHS \_ ij} sin ( θ ) + {V}_{SHC \_ ij} sin ( 2 θ ) + {V}_{SHS \_ ij} sin ( 2 θ ) \qquad ( 1 )$$

where V_{DC_ij} represents a DC voltage coefficient, V_{FHC_ij} and V_{FHS_ij} represent first order harmonic cosine and first order harmonic sine voltage coefficients (also referred to herein as first harmonic cosine and first harmonic sine voltage coefficients), and V_{SHC_ij} and V_{SHS_ij} represent second order harmonic cosine and second order harmonic sine voltage coefficients (also referred to herein as second harmonic cosine and second harmonic sine voltage coefficients). The ij refer to the transmitter receiver couplings, which may include, for example, one or more direct couplings (such as xx and zz couplings) and one or more cross couplings (such xz and zx couplings) from any number of transmitters i and receivers j. The ij subscripts are removed from subsequent equations for simplicity; however, the disclosed embodiments may utilize electromagnetic logging tools employing any number of transmitting and receiving antennas deployed in any number of corresponding, spaced apart transmitters and receivers.

The harmonic voltage coefficients in Equation 1 can be obtained, for example, using a least square curve fitting algorithm (or other suitable algorithm) from a collection of voltage measurements (e.g., made at the same depth). The coefficients are related to the coupling tensor (and therefore the properties of the formation) as described in more detail below. The disclosed embodiments are not limited to the above described second order harmonic equation.

With continued reference to FIG. 3, the wellbore (or BHA) curvature may be measured or estimated at 130 using substantially any suitable method. As is known to those of ordinary skill in the art, wellbore curvature describes the degree to which a wellbore is curved or deviates from a straight line and is commonly defined in one of two ways in the industry (although numerous others are possible). First, curvature may be quantified by specifying the build rate and the turn rate of the wellbore, where build rate refers to the vertical component of the curvature (i.e., a change in the inclination of the borehole with depth) and turn rate refers to the horizontal component of the curvature (i.e., a change in the azimuth of the borehole with depth). Curvature may also be quantified by specifying the dogleg severity and the toolface of the borehole where dogleg severity refers to the magnitude of the curvature (i.e., the severity or degree of the curve of the borehole) and toolface refers to the angular direction towards which the wellbore is turning (e.g., relative to the high side or magnetic north when looking down the borehole).

It will be appreciated that the term toolface (or toolface angle) is used herein to refer to two distinct quantities (both consistent with use of the term in the industry). In the first sense (or first use of the term), toolface or toolface angle refers to the rotational orientation of the tool (e.g., the rotational orientation of the x-axis with respect to a reference such as high side or magnetic north) as it rotates in the wellbore. In the second sense (as it pertains to curvature), toolface or toolface angle refers to the direction of curvature or bending (with respect to a reference direction). In this sense, toolface defines the direction towards which the BHA is bending. This direction is also referred to herein as the bending direction of the BHA.

Wellbore curvature may be measured, for example, via making attitude measurements (e.g., inclination and azimuth measurements) at first and second longitudinally spaced locations on the drill string. The first and second locations may be separated by substantially any suitable distance, for example, in a range from about 5 to about 200 feet. The attitude measurements may be made, for example, using triaxial accelerometer, triaxial magnetometer, and/or triaxial gyroscopic sensors deployed at a steering tool located below the electromagnetic logging tool and at a measurement while drilling tool located above electromagnetic logging tool. Such attitude measurements may, by their very nature, define a build rate (a change of inclination per unit distance along the longitudinal axis of the string) and a turn rate (a change in azimuth). Those of ordinary skill in the art will readily be able to convert build rate and turn rate to dogleg severity and toolface (bending direction).

Wellbore curvature may alternatively and/or additionally be obtained from attitude measurements made at a single location on the BHA. Each attitude measurement may be assigned a measured depth as drilling progresses. The curvature of the wellbore may be computed from any two or more of such spaced attitude measurements.

As is known to those of ordinary skill in the art, wellbore attitude measurements may be made substantially continuously while drilling or at periodic intervals, for example, during a static survey when the drill string is off bottom and additional joints of drill pipe are being added. Continuous surveying measurements may be made, for example, as disclosed in commonly assigned U.S. Pat. No. 9,273,547.

The dogleg severity and toolface angle (bending direction) may be computed from first and second spaced attitude measurements (inclination and azimuth measurements), for example, as follows:

$$DogLeg = \frac{δ}{d} \qquad ( 2 )$$

$$ToolFace = arc cos [ \frac{cos ( Inc 1 ) cos ( δ ) - cos ( Inc 2 )}{sin ( Inc 1 ) sin ( δ )} ] \qquad ( 3 )$$

where DogLeg represents the dogleg severity, ToolFace represents the bending direction, d represents the longitudinal distance between the first and second locations, and δ represents the magnitude of the bending angle and may be given, for example, as:

$$δ = arc cos [ cos ( Azi 2 - Azi 1 ) sin ( Inc 1 ) sin ( Inc 2 ) + cos ( Inc 1 ) cos ( Inc 2 ) ] \qquad ( 4 )$$

where Inc1 and Inc2 represent the measured inclination values at the first and second locations and Azi1 and Azi2 represent the measured azimuth values at the first and second locations.

With continued reference to FIG. 3, it will be appreciated that the disclosed embodiments are not limited to measuring the curvature (or computing the curvature from attitude measurements as described above). In certain embodiments the wellbore curvature may alternatively be estimated from the well plan. For example, if a well plan calls for a section of a wellbore to be drilled with a particular curvature (e.g., having particular build and turn rates or particular dogleg severity and toolface) then the wellbore curvature may be taken in 130 to be equivalent to the curvature on the well plan.

Alternatively, the wellbore curvature may be estimated from steering tool settings. For example, many commercial rotary steerable systems enable a wellbore to be drilled with a desired curvature (e.g., according to plan). The wellbore curvature may be taken in 130 to be equivalent to this desired curvature. Moreover, to drill a desired curvature, many rotary steerable systems alternate between bias and neutral phases while drilling. The ratio of time spent in the bias phase to the time spent in the neutral phase is commonly referred to as the steering ratio and is intended to control wellbore curvature. The magnitude of the wellbore curvature may also be taken in 130 to be equal to the steering ratio times a theoretical maximum dogleg for the steering tool. In such embodiments, the bend direction (toolface) may be taken to be equal to the steering toolface obtained from the steering tool. Based on the foregoing it will be appreciated that the disclosed embodiments are in no way limited to any particular means for determining, measuring, or estimating the wellbore curvature in 130.

With continued reference to FIG. 3, the electromagnetic measurements made in 120 and the curvature obtained in 130 are processed in combination (together) at 140 to compute various formation properties, for example, a formation resistivity and/or permittivity, vertical and horizontal resistivity and/or permittivity values for one or more formation layers, distances between layers and/or between the logging tool and a formation boundary, and a dip angle of the formation layers and/or boundaries with respect to the wellbore. These properties may be obtained, for example, via inversion using a forward model that accounts for BHA bending as described in more detail below.

The current flow \vec{J} due to an electric field \vec{E} applied to a material with conductivity σ is not necessarily in the same direction as the applied electric field. This effect may be expressed, for example, as follows:

$$\vec{J} = σ \vec{E} \qquad ( 5 )$$

$${J}_{x} = {σ}_{xx} {E}_{x} + {σ}_{xy} {E}_{y} + {σ}_{xz} {E}_{z}$$

$${J}_{y} = {σ}_{yx} {E}_{x} + {σ}_{yy} {E}_{y} + {σ}_{yz} {E}_{z}$$

$${J}_{z} = {σ}_{zx} {E}_{x} + {σ}_{zy} {E}_{y} + {σ}_{zz} {E}_{z}$$

In general the earth is anisotropic and its electrical properties may be expressed as a three-dimensional tensor that contains information on formation resistivity, anisotropy, dip, bed boundaries, and other aspects of formation geometry, for example, as follows:

$$σ = [ \begin{matrix}{σ}_{xx} & {σ}_{xy} & {σ}_{xz} \\ {σ}_{yx} & {σ}_{yy} & {σ}_{yz} \\ {σ}_{zx} & {σ}_{zy} & {σ}_{zz}\end{matrix} ] \qquad ( 6 )$$

Traditional propagation and induction measurements utilizing only axial coils are only sensitive to a fraction of the full conductivity tensor. The mutual inductive couplings between 3 mutual orthogonal collocated transmitter coils and 3 mutually orthogonal collocated receiver coils form a tensor and have sensitivity to the full conductivity tensor given above. In principle, measurements of these fundamental triaxial couplings can be inferred from a triaxial measurement and can be written compactly in matrix form, for example, as follows:

$${V}_{induced} {=}^{m} IZ = [ \begin{matrix}{I}_{x} & 0 & 0 \\ 0 & {I}_{y} & 0 \\ 0 & 0 & {I}_{z}\end{matrix} ] [ \begin{matrix}{Z}_{xx} & {Z}_{xy} & {Z}_{xz} \\ {Z}_{yx} & {Z}_{yy} & {Z}_{yz} \\ {Z}_{zx} & {Z}_{zy} & {Z}_{zz}\end{matrix} ] \qquad ( 7 )$$

where V_{induced} represents the matrix of induced voltage measurements, I represents the matrix of transmitter currents, and Z represents the matrix of transfer impedances (couplings) which depend on the electrical and magnetic properties of the environment surrounding the antenna pair in addition to the measurement frequency and the geometry and spacing of the antennas. The subscripts (x, y, and z) refer to the transmitter and receiver directions (with x and y referring to transverse directions and z referring to the axial direction). For example, Zₓₓ represents the mutual coupling between an x-axis transmitter (firing with current Iₓ) and an x-axis receiver, Z_{yx} represents mutual coupling between a y-axis transmitter firing with current I_{y} and x-axis receiver, and so on. The symbol m is used throughout to denote when a measurement is ‘modeled as’.

While it may be desirable to measure the full voltage tensor shown above in Equation 7 (e.g., using a triaxial transmitter and a triaxial receiver), such measurements are not always feasible or practical. In practice, tilted antennas are commonly used in applications where it is desirable to make fewer voltage measurements yet still obtain as many tensor impedance (coupling) components as possible.

In general, the antenna moments are not necessarily aligned with the x, y, and z tool axes. In such cases, the moment may be written as a generalized gain times a unit vector that points in the direction normal to the area enclosed by the antenna coil, for example, as follows:

$$V {=}^{m} {[ \begin{matrix}{m}_{Txx} & {m}_{Txy} & {m}_{Txz} \\ {m}_{Tyx} & {m}_{Tyy} & {m}_{Tyz} \\ {m}_{Tzx} & {m}_{tzy} & {m}_{Tzz}\end{matrix} ]}^{t} Z [ \begin{matrix}{m}_{Rxx} & {m}_{Rxy} & {m}_{Rxz} \\ {m}_{Ryx} & {m}_{Ryy} & {m}_{Ryz} \\ {m}_{Rzx} & {m}_{Rzy} & {m}_{Rzz}\end{matrix} ] = {{m}_{T}}^{t} {Zm}_{R} \qquad ( 8 )$$

where m_{Txx}, m_{Tyx}, M_{Tzx} represent a projection of a unit vector that is in the same direction as the ‘x’ transmitter moment on the x, y, and z tool axes; m_{Txy}, m_{Tyy}, m_{Tzy} represent a projection of a unit vector that is in the same direction as the ‘y’ transmitter moment on the x, y, and z tool axes; and m_{Txz}, m_{Tyz}, M_{Tzz} represent a projection of a unit vector that is in the same direction as the ‘z’ transmitter moment on the x, y, and z tool axes. Similarly, m_{Rxx}, m_{Ryx}, M_{Rzx} represent a projection of a unit vector that is in the same direction as the ‘x’ receiver moment on the x, y, and z tool axes; m_{Rxy}, m_{Ryy}, m_{Rzy} represent a projection of a unit vector that is in the same direction as the ‘y’ receiver moment on the x, y, and z tool axes; and m_{Rxz}, m_{Ryz}, M_{Rzz} represent a projection of a unit vector that is in the same direction as the ‘z’ receiver moment on the x, y, and z tool axes. Note that the subscripts of each element tensor do not necessarily refer to specific directions, but now simply serve to label them. For example, the voltage Vry is the voltage measured on the receiver coil labeled ‘y’ that is not necessarily in the y direction when the transmitter labeled as the ‘x’ transmitter that is not necessarily aligned with the x direction fires. Note also that the superscript t represents the matrix transpose throughout.

As described above with respect to FIG. 3, the electromagnetic measurements are made while the BHA is rotating (e.g., via rotating the drill string at the surface). In the absence of BHA bending (and in particular bending of the electromagnetic logging tool), the transmitter and receiver both rotate about the same axis (the z-axis by convention). The rotated moments (owing to rotation of the BHA) may be expressed, for example as follows:

$${{m}^{′}}_{T} = {R}_{θ} {m}_{T} \qquad ( 9 )$$

$${{m}^{′}}_{R} = {R}_{θ} {m}_{R}$$

where \acute{m}_{T} and \acute{m}_{R} represent the rotated moments, m_{T} and m_{R} are as defined above, and R_{θ} represents the rotation matrix for rotation about the BHA axis by angle θ and may be expressed, for example, as follows:

$${R}_{θ} = [ \begin{matrix}cos ( θ ) & - sin ( θ ) & 0 \\ sin ( θ ) & cos ( θ ) & 0 \\ 0 & 0 & 1\end{matrix} ]$$

The measured voltage(s) may then be expressed, for example, as follows:

$$V {=}^{m} {{m}_{T}}^{t} ( {{R}_{θ}}^{t} {ZR}_{θ} ) {m}_{R} \qquad ( 10 )$$

The rotated coupling tensor may be expressed in terms θ (in particular in terms of sines and cosines of θ), for example, as follows:

$${R}_{T}^{t} Z {R}_{R} = {Z}_{D C} + {Z}_{F H C} cos ( θ ) + {Z}_{F H S} sin ( θ ) + {Z}_{S H C} cos ( 2 θ ) + {Z}_{S H S} sin ( 2 θ ) \qquad ( 11 )$$

such that the measured voltage(s) vary with θ as given above in Equation 1. In the absence of bending, the coupling harmonics Z_{DC}, Z_{FHC}, Z_{FHS}, Z_{SHC}, and Z_{SHS} may be expressed in terms of individual ones of the transfer impedances (couplings), for example, as follows:

$${Z}_{D C} = [ \begin{matrix}\frac{{Z}_{x x} + {Z}_{y y}}{2} & \frac{( {Z}_{xy} - {Z}_{yx} )}{2} & 0 \\ - \frac{( {Z}_{xy} - {Z}_{yx} )}{2} & \frac{{Z}_{x x} + {Z}_{y y}}{2} & 0 \\ 0 & 0 & {Z}_{zz}\end{matrix} ] , {Z}_{F H C} = [ \begin{matrix}0 & 0 & {Z}_{x z} \\ 0 & 0 & {Z}_{y z} \\ {Z}_{z x} & {Z}_{z y} & 0\end{matrix} ] , \qquad ( 12 )$$

$${Z}_{F H S} = [ \begin{matrix}0 & 0 & {Z}_{y z} \\ 0 & 0 & - {Z}_{x z} \\ {Z}_{z y} & - {Z}_{z x} & 0\end{matrix} ] , {Z}_{S H C} = [ \begin{matrix}\frac{{Z}_{x x} + {Z}_{y y}}{2} & \frac{( {Z}_{xy} - {Z}_{yx} )}{2} & 0 \\ \frac{( {Z}_{xy} - {Z}_{yx} )}{2} & - \frac{( {Z}_{x x} + {Z}_{y y} )}{2} & 0 \\ 0 & 0 & 0\end{matrix} ] ,$$

$${Z}_{S H S} = [ \begin{matrix}\frac{( {Z}_{xy} - {Z}_{yx} )}{2} & - \frac{( {Z}_{x x} + {Z}_{y y} )}{2} & 0 \\ - \frac{( {Z}_{x x} + {Z}_{y y} )}{2} & - \frac{( {Z}_{xy} - {Z}_{yx} )}{2} & 0 \\ 0 & 0 & 0\end{matrix} ]$$

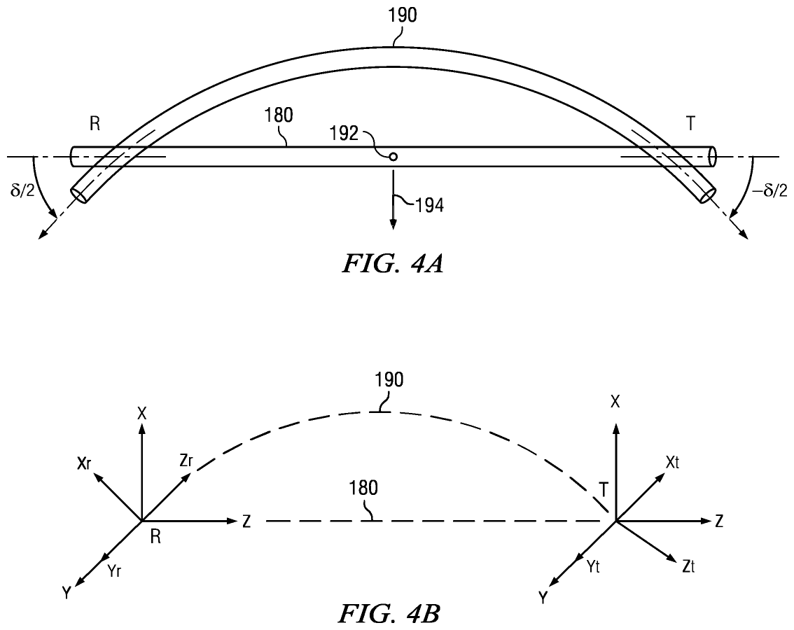

FIGS. 4A and 4B (collectively FIG. 4) schematically depict tool (or BHA) bending in a single plane. In the depicted schematic, the original (unbent) tool is shown at 180 and the bent tool is shown at 190. In this reference frame, the transmitter T and the receiver R may be thought of as being rotated about a bending axis that is located at the midpoint between the transmitter and receiver (e.g., pointing into the page at 192) and is perpendicular to both the bending plane (the plane of the FIGURE) and the bending direction 194. In this reference frame, the receiver R is rotated about the bending axis by an angle δ/2 and the transmitter T is rotated about the bending axis by an angle −δ/2 (making a total bending angle of δ).

It will be appreciated that bending does not appreciably change the distance (spacing) between the transmitter and receiver for the bending angles commonly encountered in subterranean drilling operations (e.g., having a dogleg severity of less than about 15 degrees per 100 feet). The spacing change Δ (the change in distance between the transmitter and receiver) caused by bending may be expressed, for example, as follows:

$$Δ = L - ( \frac{2 L}{δ} ) sin ( \frac{δ}{2} ) \qquad ( 13 )$$

where L represents the original spacing between the transmitter and receiver and δ represents the bending angle as described above. Note that Δ approaches zero (Δ=L−L) for small bend angles. Even for drilling operations having a high dogleg the spacing change is negligible. For example, in a deep reading embodiment in which the spacing between the transmitter and the receiver is L=100 ft and the dogleg severity is high at 15 degrees per 100 feet, the spacing change between the transmitter and receiver is approximately −3.4 inches (about −0.3 percent).

Turning again to FIG. 4B, it can be seen that tool bending (or BHA bending) changes the local axes of the transmitter and receiver such that the local z-axes (zₜ and zᵣ) no long point in the same direction. Note that the z-axis of the receiver R is angularly offset from the z-axis of the transmitter T by an angle δ in this example. As such, the transmitter and receiver antennas no longer rotate about the original z-axis as the tool rotates in the wellbore, but instead rotate about zₜ and zᵣ, respectively. The x-axes and y-axes of the transmitter may also be angularly offset from the original axes depending on the bending axis. In the depiction on FIG. 4B, the bending axis is parallel with the y-axis such that only the x and z axes are angularly offset from the original axes. The disclosed embodiments are of course not limited in this regard.

Rotation of the transmitter and receiver antennas as the tool rotates in the wellbore may be expressed mathematically, for example, by first applying a rotation to the transmitter and receiver antennas about the bend axis to obtain new rotation axes zₜ and zᵣ and then rotating the transmitter and receiver antennas about the new axes. In this example coordinate system (reference frame), the original z-axis may be defined by a line passing through the transmitter and receiver positions as depicted on FIG. 4, and the rotated transmitter and receiver moments may be expressed, mathematically, for example, as follows:

$$\begin{matrix}{{m}^{´}}_{T} = {R}_{T θ} {R}_{T b e n d} {m}_{T} \\ {{m}^{´}}_{R} = {R}_{R θ} {R}_{R b e n d} {m}_{R}\end{matrix} \qquad ( 14 )$$

where \acute{m}_{T}, \acute{m}_{R}, m_{T} and m_{R} are as defined above, R_{Tθ} and R_{Rθ} represent the rotation matrices describing rotation of the transmitter and receiver through the angle θ about the new transmitter and receiver orientations, and R_{Tbend} and R_{Rbend} represent rotation matrices of the transmitter and receiver about the bend axis.

Rotation matrices R_{Tbend} and R_{Rbend} may be obtained, for example, according to the following expression:

$${R}_{\hat{u} φ} = I cos ( φ ) + sin ( φ ) {A}_{\hat{u}} + ( 1 - cos ( φ ) ) {B}_{\hat{u}} \qquad ( 15 )$$

where R_{ûφ} represents a rotation matrix for rotation about a rotation axis represented by the unit vector û through an angle φ, I represents the 3×3 identity matrix, and where:

$$\begin{matrix}{A}_{\hat{u}} = [ \begin{matrix}0 & - {u}_{z} & {u}_{y} \\ {u}_{z} & 0 & - {u}_{x} \\ - {u}_{y} & {u}_{x} & 0\end{matrix} ] \\ {B}_{\hat{u}} = [ \begin{matrix}{u}_{x}^{2} & {u}_{x} {u}_{y} & {u}_{x} {u}_{z} \\ {u}_{x} {u}_{y} & {u}_{y}^{2} & {u}_{y} {u}_{z} \\ {u}_{x} {u}_{z} & {u}_{y} {u}_{z} & {u}_{z}^{2}\end{matrix} ]\end{matrix} \qquad ( 16 )$$

With continued reference to FIG. 4, it will be appreciated that bending axis û is orthogonal to both the z-axis and the bending toolface (the direction of the bend) and may be expressed as:

$$\hat{u} = \hat{z} \times \hat{b} = [ \begin{matrix}- sin ( τ ) \\ cos ( τ ) \\ 0\end{matrix} ] \qquad ( 17 )$$

where × represents the vector cross product, \hat{z} represents the z-axis such that

$$\hat{z} = [ \begin{matrix}0 \\ 0 \\ 1\end{matrix} ] ,$$

and \hat{b} represents the bending toolface direction such that

$$\hat{b} = [ \begin{matrix}cos ( τ ) \\ sin ( τ ) \\ 0\end{matrix} ] ,$$

where τ represents the toolface angle (the bending direction).

Substituting equation 17 into equation 16 yields the following:

$${A}_{\hat{u}} = [ \begin{matrix}0 & 0 & cos ( τ ) \\ 0 & 0 & sin ( τ ) \\ - cos ( τ ) & - sin ( τ ) & 0\end{matrix} ] \qquad ( 18 )$$

$${B}_{\hat{u}} = [ \begin{matrix}{sin}^{2} ( τ ) & - sin ( τ ) cos ( τ ) & 0 \\ - sin ( τ ) cos ( τ ) & {cos}^{2} ( τ ) & 0 \\ 0 & 0 & 0\end{matrix} ]$$

As noted above, in the depicted reference frame, the receiver is rotated by a bending angle of δ/2 and the transmitter is rotated by a bending angle of −δ/2. It will be appreciated that the disclosure is not limited by the above described reference frame. More broadly, the bending reference frame may be with respect to substantially any location on the string (e.g., at the transmitter or at the receiver) with the bending angle magnitudes being adjusted accordingly. In the above described example reference frame, rotation matrices R_{Tbend} and R_{Rbend} may expressed, for example, as follows:

$$\begin{matrix}{R}_{T b e n d} = cos ( \frac{δ}{2} ) I - sin ( \frac{δ}{2} ) {A}_{\hat{u}} + ( 1 - cos ( \frac{δ}{2} ) ) {B}_{\hat{u}} \\ {R}_{R b e n d} = cos ( \frac{δ}{2} ) I + sin ( \frac{δ}{2} ) {A}_{\hat{u}} + ( 1 - cos ( \frac{δ}{2} ) ) {B}_{\hat{u}}\end{matrix} \qquad ( 19 )$$

Substituting equation 18 into equation 19 yields the following rotation matrices for the transmitter and receiver:

$${R}_{T b e n d} = [ \begin{matrix}sin {( τ )}^{2} + cos {( τ )}^{2} cos ( \frac{δ}{2} ) & \frac{sin ( 2 τ )}{2} ( cos ( \frac{δ}{2} ) - 1 ) & - cos ( τ ) sin ( \frac{δ}{2} ) \\ \frac{sin ( 2 τ )}{2} ( cos ( \frac{δ}{2} ) - 1 ) & cos {( τ )}^{2} + sin {( τ )}^{2} cos ( \frac{δ}{2} ) & - sin ( τ ) sin ( \frac{δ}{2} ) \\ cos ( τ ) sin ( \frac{δ}{2} ) & sin ( τ ) sin ( \frac{δ}{2} ) & cos ( \frac{δ}{2} )\end{matrix} ] \qquad ( 20 )$$

$${R}_{R b e n d} = [ \begin{matrix}sin {( τ )}^{2} + cos {( τ )}^{2} cos ( \frac{δ}{2} ) & \frac{sin ( 2 τ )}{2} ( cos ( \frac{δ}{2} ) - 1 ) & cos ( τ ) sin ( \frac{δ}{2} ) \\ \frac{sin ( 2 τ )}{2} ( cos ( \frac{δ}{2} ) - 1 ) & cos {( τ )}^{2} + sin {( τ )}^{2} cos ( \frac{δ}{2} ) & sin ( τ ) sin ( \frac{δ}{2} ) \\ - cos ( τ ) sin ( \frac{δ}{2} ) & - sin ( τ ) sin ( \frac{δ}{2} ) & cos ( \frac{δ}{2} )\end{matrix} ]$$

As noted above with respect to FIG. 4, bending changes the local axes of the transmitter and receiver such that they point in different directions. The new axial directions of the transmitter and receiver (after bending) may be expressed, for example, as follows:

$${z}_{t} = [ \begin{matrix}- cos ( τ ) sin ( \frac{δ}{2} ) \\ - sin ( τ ) sin ( \frac{δ}{2} ) \\ cos ( \frac{δ}{2} )\end{matrix} ] \qquad ( 21 )$$

$${z}_{r} = [ \begin{matrix}cos ( τ ) sin ( \frac{δ}{2} ) \\ sin ( τ ) sin ( \frac{δ}{2} ) \\ cos ( \frac{δ}{2} )\end{matrix} ] \qquad ( 22 )$$

where zₜ and zᵣ represent the directions of the transmitter and receiver after bending. The transmitter and receiver rotate about their local z-axes (as given in Equations 21 and 22) as the BHA rotates in the wellbore such that rotation matrices R_{Tθ} and R_{Rθ} may be expressed, for example, as follows:

$$\begin{matrix}{R}_{T θ} = cos ( θ ) I + sin ( θ ) {A}_{{z}_{t}} + ( 1 - cos ( θ ) ) {B}_{{z}_{t}} \\ {R}_{R θ} = cos ( θ ) I + sin ( θ ) {A}_{{z}_{r}} + ( 1 - cos ( θ ) ) {B}_{{z}_{r}}\end{matrix} \qquad ( 23 )$$

where the matrices A_{z}_{ₜ} and B_{z}_{ₜ} may be obtained by combining equations 16 and 21 and the matrices A_{z}_{ᵣ} and B_{z}_{ᵣ} may be obtained by combining equations 16 and 22.

The voltage V between the transmitter and receiver may be expressed, for example, as follows:

$$V = {m}_{T}^{t} ( {R}_{Tbend}^{t} {R}_{T θ}^{t} {ZR}_{R θ} {R}_{R b e n d} ) {m}_{R} \qquad ( 24 )$$

With reference again to FIG. 3, the electromagnetic measurements and estimated or measured curvature are processed in combination at 140 to compute one or more properties of the subterranean formation through which the wellbore penetrates. For example, the electromagnetic measurements may be processed in combination with the curvature using an inversion algorithm to compute the at least one property.

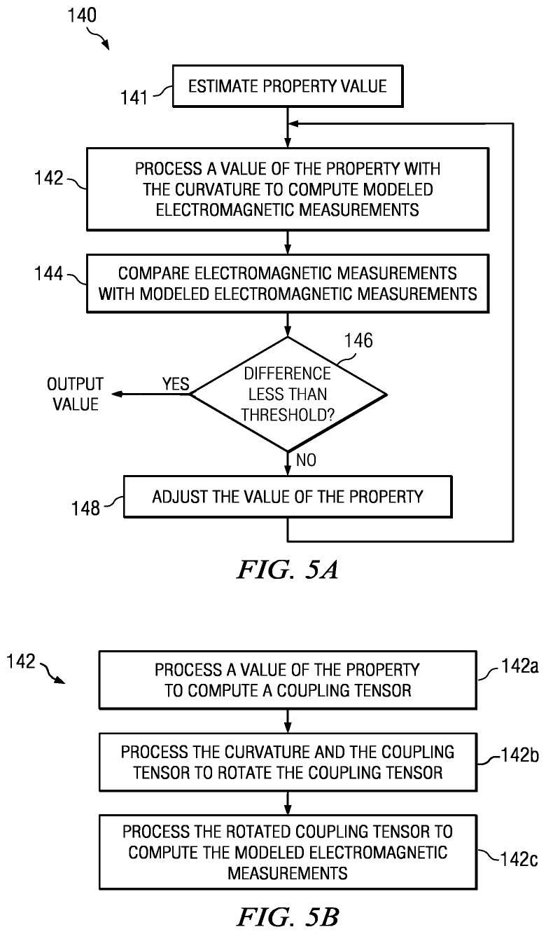

Turning now to FIGS. 5A and 5B, example embodiments of block 140 in FIG. 3 are depicted. In FIG. 5A, an initial estimate of the formation property value (or estimates of values of multiple properties) is received at 141. The formation property value and the curvature estimate are input into a forward model to compute modeled electromagnetic logging measurements at 142. The modeled measurements computed in 142 are compared at 144 with the measurements made in 120 to compute a difference (or an error). The difference is in turn compared with a threshold at 146. The value of the at least one property (or values of the multiple properties) is adjusted at 148 when the difference is greater than the threshold. Blocks 142, 144, 146 and 148 are repeated until the difference is less than the threshold at which point the value of the at least one property is output.

FIG. 5B depicts one example embodiment of block 142 in more detail. At 142a the formation property value (the initial estimate or the adjusted value) is used (processed in the forward model) to compute a coupling tensor between the transmitter and the receiver. As described above the coupling tensor depends on the formation properties as well as the configuration of the logging tool (including the configuration of and spacing between the transmitter and receiver and the measurement frequency). The computed coupling tensor is then rotated at 142b about the bend axis by the magnitude of the bend angle as described above (based on the estimated curvature). The rotated coupling tensor is then further processed at 142c to compute the modeled electromagnetic logging measurements.

With continued reference to FIG. 5B, the bending angle and the bending axis may be obtained from the curvature in 142b, for example, as described above with respect to Equations 2-4 and 17-19. The coupling tensor may then be rotated in 142b, for example, as described above with respect Equations 19-24. Moreover, 142c may further comprise computing new rotation axes for the transmitter and the receiver (e.g., as described above with respect to Equations 20-22) about which the coupling tensors may be further rotated to model BHA rotation in the wellbore (e.g., as described in more detail above with respect to Equations 23 and 24).

With still further reference to FIGS. 5A and 5B, the modeled electromagnetic logging measurements may include substantially any suitable electromagnetic measurements (or measurements expressed in substantially any suitable form). In certain advantageous embodiments, the modeled electromagnetic logging measurements include or are derived from modeled harmonic voltage coefficients, for example, including the modeled DC, first order, and second order coefficients, ratios of certain harmonic voltage coefficients to other modeled voltage coefficients, or ratios of modeled harmonic voltage coefficients to reference quantities such as a calibration coefficient or factor. The modeled electromagnetic logging measurements may further include various tensor couplings or combinations of tensor couplings derived from the modeled harmonic voltage coefficients. Such tensor couplings may include those described above, for example, including xx, yy, and zz direct couplings and xz, zx, yz, zy, xy, and yx cross couplings. The tensor couplings may further include quantities related to various combinations of the tensor couplings including, for example, various ratios, gain compensated quantities, symmetrized and anti-symmetrized quantities. Example tensor coupling combinations are disclosed in commonly assigned U.S. Pat. Nos. 9,448,324; 9,618,687; 9,766,365; 9,784,880; 9,835,753; 9835,755; 10,215,878; and 10,371,852. The above described modeled harmonic voltage coefficients and/or derived quantities may be compared with corresponding measured quantities at 144 (FIG. 5A) to invert for the at least one formation property.

As described herein, the electromagnetic measurements and the wellbore curvature may be processed (e.g., via inversion modeling) to determine at least one (and sometimes many) electromagnetic and physical properties of a subterranean formation surrounding a curved section of a wellbore. These properties may be further evaluated to guide (steer) subsequent drilling of the wellbore, for example, during a pay-zone steering operation in which it is desirable to maintain the wellbore within a particular formation layer (i.e., the pay-zone) or in proximity to a formation boundary or other feature.

The various processes in the disclosed measurement methods may be implemented on a downhole processor (controller). By downhole processor it is meant an electronic processor (e.g., a microprocessor or digital controller) deployed in the drill string (e.g., in the electromagnetic logging tool or elsewhere in the BHA). In such embodiments, the electromagnetic measurements and the curvature may be processed in combination by the downhole processor to compute at least one formation property. In other embodiments, the electromagnetic measurements and/or the curvature may be transmitted to the surface (e.g., via known telemetry techniques) and processed using a surface computer. Irrespective of where the measurements are processed a disclosed system for making electromagnetic measurements in a curved section of a wellbore may include an electromagnetic logging tool, for example, as described above and a processor (uphole or downhole) configured to process electromagnetic measurements in combination with a curvature of the curved section of the wellbore to compute at least one property the formation surrounding the wellbore.

Although methods making electromagnetic measurements that account for BHA bending have been described in detail, it should be understood that various changes, substitutions and alternations can be made herein without departing from the spirit and scope of the disclosure as defined by the appended claims.

The embodiments of the method have been primarily described with reference for use with LWD resistivity tools; however, the method may be used in applications other than the drilling of a wellbore. In other embodiments, systems according to the present disclosure may be used in wireline operations, however, other potential uses can be envisioned. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. Changes that come within the meaning and range of equivalency of the claims are to be embraced within their scope.

1. A method for making electromagnetic logging measurements in a curved section of a subterranean wellbore, the method comprising:
(a) rotating an electromagnetic logging tool in the curved section of the wellbore, the electromagnetic logging tool including at least one transmitter spaced apart from at least one receiver;
(b) causing the electromagnetic logging tool to make electromagnetic logging measurements while rotating in (a);
(c) obtaining a curvature of the curved section of the wellbore; and
(d) processing the electromagnetic measurements made in (b) in combination with the curvature obtained in (c) to compute at least one property of a formation surrounding the wellbore.

2. The method of claim 1, wherein at least one of the transmitter and the receiver comprises an axial antenna and a transverse antenna.

3. The method of claim 1, wherein at least one of the transmitter and the receiver comprises a triaxial antenna arrangement.

4. The method of claim 1, wherein at least one of the transmitter and the receiver comprises a tilted antenna.

5. The method of claim 1, wherein (b) comprises:
firing the transmitter by applying a time varying electrical current to a transmitting antenna in the transmitter;
measuring a voltage response in a receiving antenna in the receiver, the voltage response induced by the current applied to the transmitting antenna;
measuring a toolface angle at a time of said transmitter firing; and
continuously repeating said firing, said measuring a voltage response, and said measuring a toolface to obtain a plurality of measured voltages at a corresponding plurality of toolface angles.

6. The method of claim 5, wherein (b) further comprises:
fitting the plurality of measured voltages to a harmonic equation to obtain a plurality of harmonic voltage coefficients.

7. The method of claim 6, wherein the harmonic voltage coefficients comprise DC, first order, and second order coefficients.

8. The method of claim 1, wherein the curvature is obtained from a well plan or a rotary steerable tool.

9. The method of claim 1, wherein the curvature is computed from first and second spaced apart wellbore attitude measurements.

10. The method of claim 1, wherein the at least one property of the formation comprises at least one of a resistivity, a vertical resistivity, a horizontal resistivity, a distance to a boundary layer, or thicknesses of one or more formation layers.

11. The method of any one of claims claim 1, wherein (d) further comprises processing the electromagnetic measurements made in (b) in combination with the curvature obtained in (c) via inverting a forward model to compute the at least one property.

12. The method of claim 11, wherein (d) further comprises:
estimating a value of the at least one property;
processing the value of the at least one property and the curvature obtained in (c) in the forward model to compute modeled electromagnetic logging measurements;
comparing the modeled logging measurements with the logging measurements made in (b) to obtain a difference; and
adjusting the value of the at least one property; and
repeating said processing the value, said comparing, and said adjusting until the difference is less than a threshold.

13. The method of claim 12, wherein said processing the value comprises:
processing the value of the at least one property to compute a coupling tensor;
processing the curvature and the coupling tensor to rotate the coupling tensor; and
processing said rotated coupling tensor to compute the modeled electromagnetic logging measurements.

14. The method of claim 13, wherein said processing the curvature and the coupling tensor to rotate the coupling tensor further comprises:
processing the curvature to obtain a bending angle and a bending axis; and
processing the bending angle, the bending axis, and the coupling tensor to rotate the coupling tensor.

15. The method of claim 13, wherein:
processing the curvature and the coupling tensor to rotate the coupling tensor further comprises computing new rotation axes for the transmitter and the receiver; and
processing said rotated coupling tensor further comprises rotating the coupling tensor about the new axes.

16. The method of claim 15, wherein processing said rotated coupling tensor further comprises computing modeled harmonic voltage coefficients.

17. The method of claim 16, wherein said comparing comprises comparing the modeled harmonic voltage coefficients with measured harmonic voltage coefficients obtained in (b).

18. A system for making electromagnetic measurements in a curved section of a subterranean wellbore, the system comprising:
at least one transmitter spaced apart from at least one receiver on a drill string, the transmitter and receiver configured to make electromagnetic measurements while the drill string rotates in the wellbore; and
a processor configured to:
receive a curvature estimate of the curved section of the wellbore; and
process electromagnetic measurements made by the transmitter and the receiver in combination with the received curvature to compute at least one property of a formation surrounding the wellbore.

19. The system of claim 18, wherein the processor is configured to compute the at least one property of the formation via:
(i) receiving an estimated value of the at least one property;
(ii) processing the value of the at least one property and the received curvature in a forward model to compute modeled electromagnetic logging measurements;
(iii) comparing the modeled electromagnetic logging measurements with the electromagnetic measurements made by the transmitter and the receiver to obtain a difference;
(iv) adjusting the value of the at least one property; and
(v) repeating (ii)-(iv) until the difference is less than a threshold.

20. The system of claim 19, wherein (ii) further comprises:
processing the value of the at least one property to compute a coupling tensor;
processing the curvature and the coupling tensor to rotate the coupling tensor; and
processing said rotated coupling tensor to compute the modeled electromagnetic logging measurements.
